(19) United States
(12) Patent Application Publication
(10) Pub. No.: US 2003/0135741 A1
(43) Pub. Date: Jul. 17, 2003

(54) Almost independent logically integrated license enforcement framework

(75) Inventor: Dmitriy R. Nuriyev, West Windsor, NJ (US)

Correspondence Address: JORDAN AND HAMBURG LLP, 122 EAST 42ND STREET, SUITE 4000, NEW YORK, NY, 10168, US

(73) Assignee: Applied Logical Systems, LLC, West Windsor, NJ

(21) Appl. No.: 10/309,716

(22) Filed: Dec. 4, 2002

Related U.S. Application Data
(60) Provisional application No. 60/338,426, filed on Dec. 4, 2001.

(51) Int. Cl. G06F 11/30

(52) U.S. Cl. 713/187

(57) ABSTRACT

A method of automatically transforming a computer program in order to control it's execution in compliance with the end user license agreement and concealing the program logic. The method allows even for distributing program's source code and still enforcing the license. In particular the execution control allows for managing the period of time and the number of times a particular instance of a program was run as well as for detecting the fact of a simultaneous execution of the same instance by several users. Allows for a very infrequent outside interaction with a secure program such that only a certain percentage of program executions causes outside connection, and no more than a fixed number of times per each such execution independently of the input data size. For each outside interaction allows for an extremely simple and independent of the client input data size secure program processing.

### FIELD OF THE INVENTION

The invention is in the field of computer software piracy protection.

### BACKGROUND OF THE INVENTION

Computer software piracy is known to be a major source of not only the revenue loss but also the loss of competitive advantage and intellectual property. Therefore a great diversity of software piracy protection systems was introduced.

Such systems usually control the period of time a computer program can be functioning for or the number of times it can be executed or limit the program's functionality. This is usually the case with the trial versions of software. Such protection systems can also control the number of users simultaneously executing a program for a given license.

A number of ways to implement such systems currently exists. Those can be grouped into three categories: one where a program runs completely within the user's computer—which we'll call closed systems and the systems that interact with the external environment—we'll call them open systems. Open systems include various types of hardware dongles, network based registration, client-server configurations where a portion of code is executed on a secure remote server. Closed systems range from the simpler systems that monitor the system date or computer name and IP address to the sophisticated checking of hardware properties such as BIOS, CPU and hard drive properties in order to identify the computer. There are also many systems that combine the properties of both open and closed systems which we'll call hybrid systems such as Microsoft's Windows and Office XP copy protection system.

At the same time it is a known fact that a closed system cannot be fully protected from unauthorized use in principle. This is because of the fact that no matter what sophisticated checks the program makes it's executable code can be reverse-engineered into the source code and the results of the checks traced to the license control statements. Some protection systems however avoid this by integrating the checks into the critical code. Such systems can be circumvented by using a replay attack where all the queries the program makes to the operating system are recorded and than replayed. The same problem is with most hybrid systems—if their outside queries are independent of the critical data, a replay attack that simulates an external connection can allow to disable them as well. On the other hand the open systems dependent on a secure server, which executes some of its code—client-server setup, can possess a very powerful protection, however this set up currently presents a compromise between the level of program protection—how much of the logically critical code runs on a client side vs. the secure server load and frequency of an outside connection.

The current systems provide either a poor code protection—only rarely executed code runs on server side or resort to client-server processing where the server has to process the amount of data dependent on the particular problem size.

This approach means that if a software vendor sells a lot of copies of some computationally intensive application to a large number of clients, then the vendor's server will be accessed every time a client runs the application. If a particular client also processes large amounts of homogeneous data such as database records or for example media files or spreadsheets then a certain, most likely critical portion of code will be executed as many times as there are such records. This means that the secure server will be executing some code for every single record the client processes. Such overhead on the server side, also given the slowness of the networks quickly becomes prohibitive. In addition to this the need to maintain a high speed outside connection becomes a serious inconvenience for the clients.

Another advantage this invention offers is an ability to provide an existing market for hardware dongles with a way to prevent the client program from getting stripped of the code that controls it's execution by communicating with the dongle. In this scenario, the secure program will reside on a dongle and since it requires very little processing time it does not require any powerful processor on the dongle.

### SUMMARY OF THE INVENTION

This invention allows at the same time to securely conceal the program's logic in such way that reverse-engineering is pointless, control the program execution depending on the license agreement and also allows to maintain a very infrequent outside connection with a small data packet sent and returned with each connection. This means that only for a given pre-defined percentage of program executions the outside secure program can be contacted. Such contact will also be only once per execution.

The transmission in this case is independent of the problem size and the processing required by the secure program is extremely simple and independent of the problem size as well. Such transmission can be compared to a simple TCP/IP “ping” command. This allows to have any number of clients executing software of any complexity on their own high-end computers almost independently of the outside connection. The packet sent to the secure program presents no privacy concerns since the information it contains represents only a slice of data processed on the client computer in such way that there is no way restore the data itself.

The base concept of this invention is that in order to adequately reflect complexity of any non-trivial algorithm one must definitely include all of it's logical conditions that control the flow of data. Based on this premise the main objective therefore becomes protection of these conditions, which this invention persuades. This allows for both upholding the license agreement and concealing the program logic. To this end this invention provides a way of aggregating the program conditions and ensuring the sufficient number of Boolean variables in order to effectively resist brute force attacks. It also combines the conditions that relate only to the base program logic with certain Boolean expression that are almost always true except for a given percentage of inputs. This allows controlling the frequency of the outside connection for a given condition execution.

This invention also provides a mechanism for ensuring that independently of the input data size the outside connection will be established with a fixed up-front frequency. This is achieved by a special transformation of program loops and conditions within them to ensure that all loops are recursive and using that to reliably establish the difference between the first set of iterations and the later ones in order to produce the controlled fault only once in the beginning of the loop execution.

Another concept of this invention is license violation trapping. Given the program is fully reverse-engineered it is impossible to have a separate condition to trap the cases when the client license is invalid. This invention produces controlled faults originating from the functionally necessary logical conditions. This is believed to be the only way of effectively resisting code analysis. Since if the program terminates immediately a special termination condition gets revealed. Instead such faults cause the program to incorrectly alter the execution flow by taking legitimate branches under the deliberately wrong conditions.

This also allows to ensure that after such controlled fault takes place the program can immediately recover from it by obtaining a correct value of such condition from the secure server.

### PRIOR ART

Distributed Execution Software Licensing Server,

Clark Jonathan application # 20010011254

The protection of computer software: its technology and applications.

Derrick Grover, 1992

### DRAWING FIGURES

FIG. 1 shows a high level program transformation steps

FIG. 2 shows protected program functioning

FIGS. 3.1-3.2 gives a high level view of the Blending Procedure

FIG. 4 shows a sample technique of converting an independent loop to a recursive one using secret key encryption

FIG. 5 shows the algorithm decomposition

FIG. 6 shows the condition protection inside the recursive loop

FIGS. 7.1-7.3 shows the initial code transformation

### DETAILED DESCRIPTION OF THE INVENTION

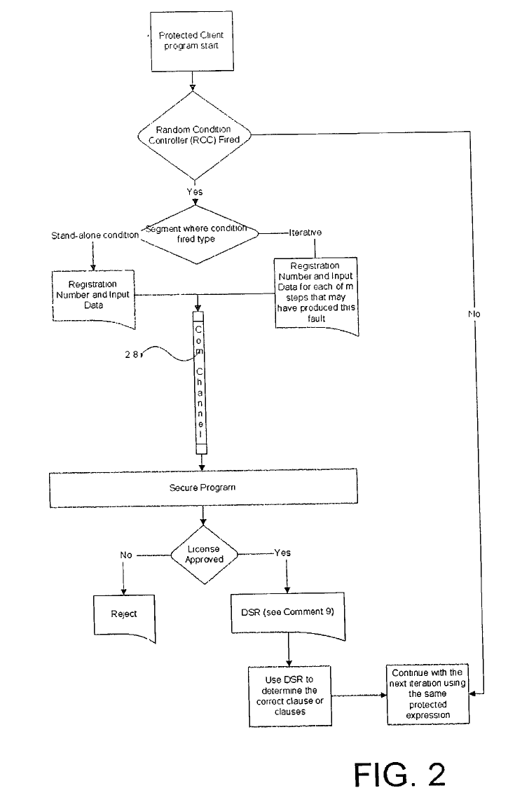

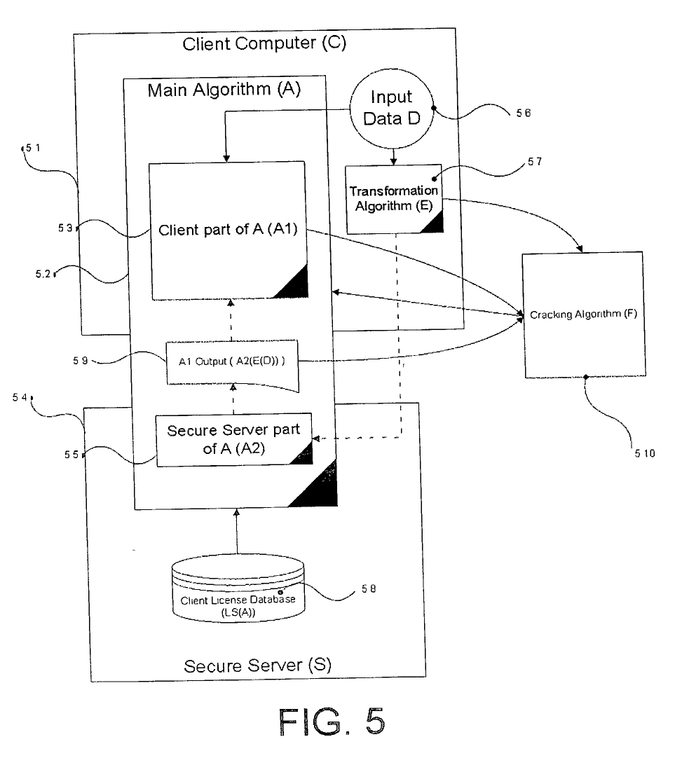

Let A is some algorithm (FIG. 5.2), D is it's input data (FIG. 5.6), TIME(A,D) is the time it takes A to process D. We shall denote client program as C (FIG. 5.3) and secure program as S (see FIG. 5.4) and communication channel Z (FIG. 2.8). The client license for A we denote as LS(A) (see FIG. 5.8) and call it a set of statements regulating whether or not, how long, how many times a particular client can use A.

Our objective is to distribute A in such way that:

a) A is executed almost entirely by client program and almost always independently of any external components;

b) LS(A) must be adhered;

Almost entirely means that if A=A₁(D)∪A₂(E(D)) (1),

where A₁ and A₂ are understood as instruction sets, A₁ is executed on C and A₂ on S (FIG. 5.5), E is some algorithm executed by C which prepares some data slice the size of O(1) for processing on S, then TIME(E) and TIME(A. ) are O(1) (independent of n). This also means that communication channel Z is used with a frequency and load independent of n as well.

At the same time b) dictates that there must be no polynomial time algorithm F:F(A₁, E , A₂ E(D))=A, (see FIG. 5.10).

To that end we do the following:

Part 1: Initial Code Transformation

Transform A to achieve iterator and conditional aggregation. Following is a C++ resembling pseudo-code of these transformation steps:

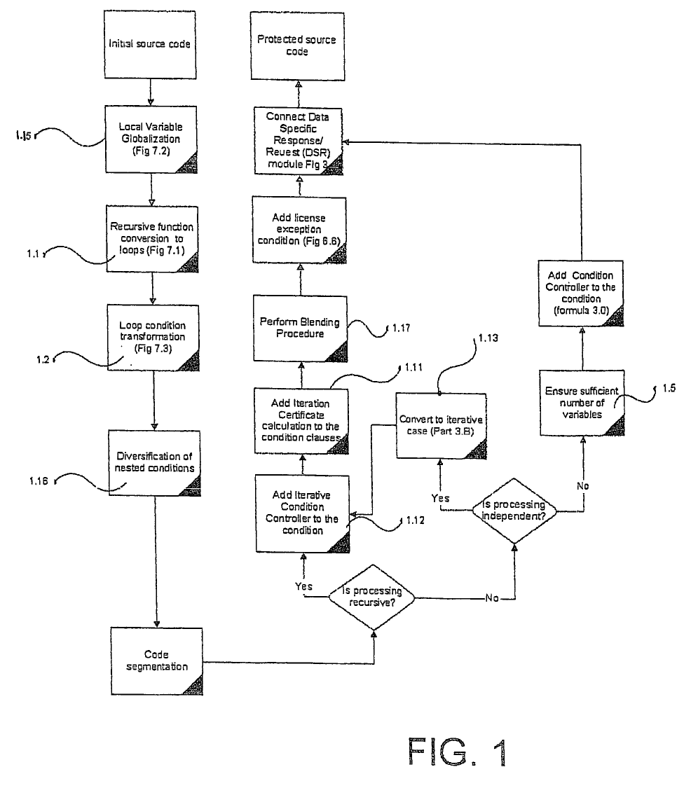

a) Translation of recursive function calls into while loops (FIG. 1.1). Let Fn( ) is a recursive function represented as:

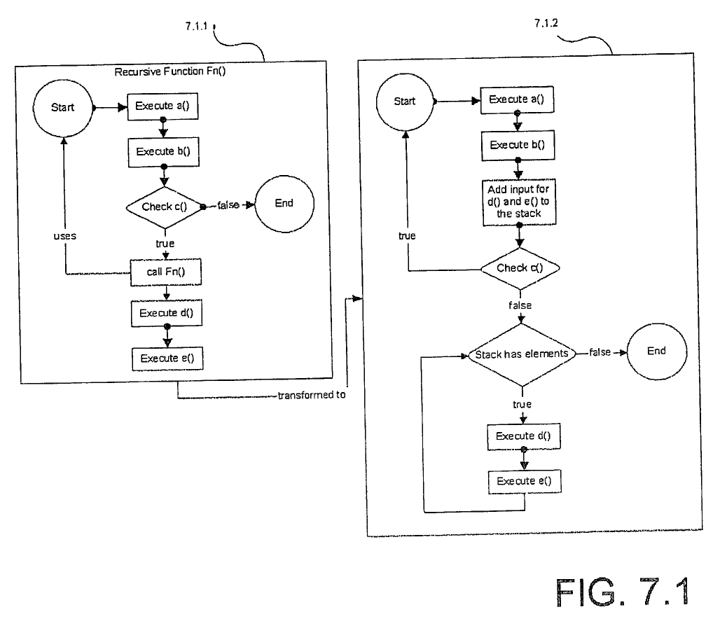

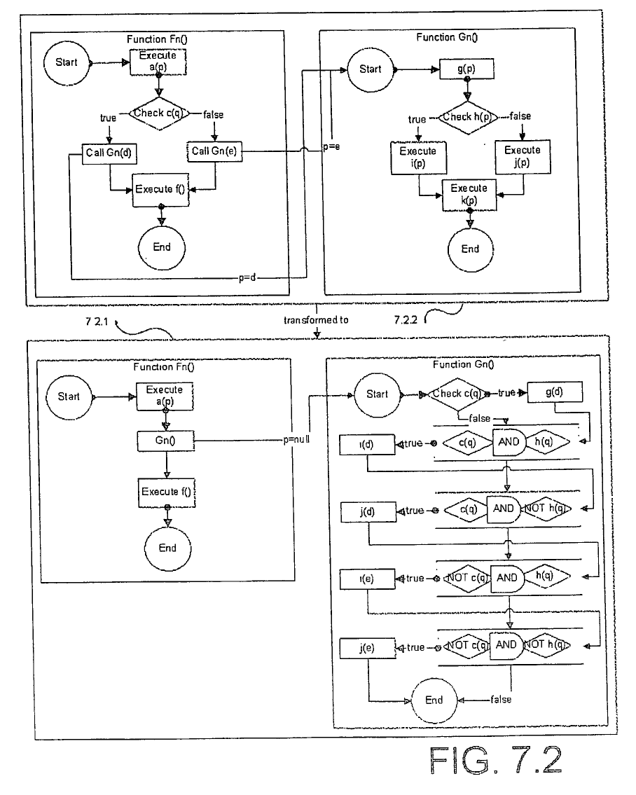

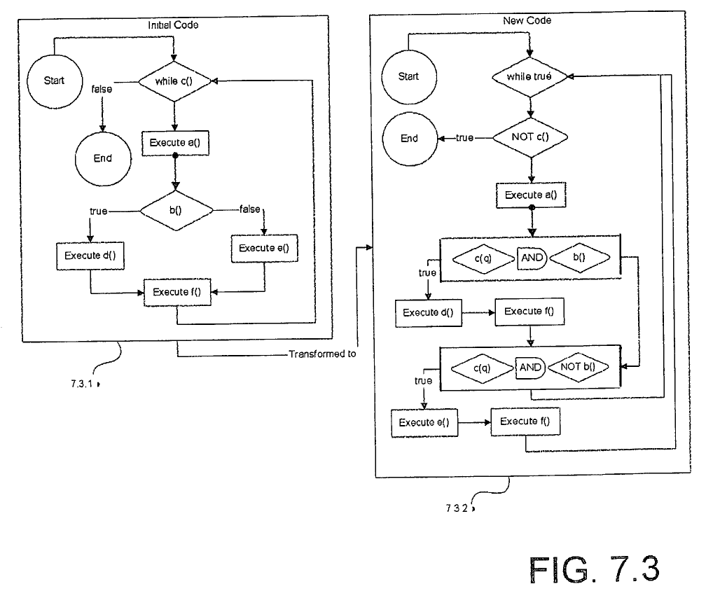

Fn {a; b; (c ? return); Fn( ); d; e; f;}—FIG. 7.1.1.

We transform it to:

while (c) (a; b; Stack.add(input(d), input (e), input (f)))) while (Stack.pop) (d; e; f;)—FIG. 7.1.2

Here input(t) is the input data for function or an instruction set t( ).

b) Local variable globalization to allow for the aggregation (FIG. 1.15). Let Fn( ) and Gn( ) are two functions across which we globalize the variables:

Fn{a; (c?Gn(d):Gn(e)); f}; Gn(p){g; (h?i(p):j(p)); k) (see FIG. 7.2.2)→

→Fn{a; Gn( ); f}; Gn{c?c&h?i(d); c&!h?j(d); !c&h?i(e); !c&!h?j(e)}(see FIG. 7.2.1)

c) Diversification of nested conditions (FIG. 1.16). We Substitute

C(b1, b2, b3)→T(s1, s2, s3, . . . ), where s1=s1(b1, b2, b3, b1, b2, b3), s2=s2( . . . ),

. . . are some Boolean expressions.

This helps in case such as:

c1(a, b, c) . . . d=f( . . . ) . . . c2(a, b, c, d) . . . e=g( . . . ) . . . c3(a, b, c, d, e)=c2(a, b, c, d) & e . . .

In this case the fact that c2 was used prior to c3 can lead to an easy guess about the structure of c3—

this can be blended if different tautologies are introduced in place of c1 and c2 . . . E.g.: given a simple a & !b→(a, b, !a, !b)→p=(a∥b) & !a, q=(a∥!b) & b & a∥a,→(a, b, !a, !b, p, q)→(s∥!s) & (a & !b) to be equivalently transformed; here s(a, b, !a, !b, p, q) is another Boolean expression.

d) Loop condition transformation and aggregation (FIG. 1.2):

while (c) (a; b?d:e; f) (see FIG. 7.3.1)→

→while (t)(!c? break; c?a; (c&b)?{d; f}; (c&!b)?{e; f}) (see FIG. 7.3.2)

in this way, also, multiple loops are translated into one.

Based on this preprocessing we are now in position to define the decomposition (1)

For an identified set P of logical conditions crucial to A and any SεP we replace S with a new Boolean condition C″=S & F, where F is such that F=f in q % of cases. Such set P could be automatically chosen to include the longest Boolean conditions obtained as a result of Part 1.

Part 2: Random Condition Controller (RCC) and Useful Boolean Systems

Let B(r) is a k dimensional space of Boolean vectors, S and F are Boolean functions on B(r). LetσεB(r) be a Boolean vector an argument for S, and p a probability. Consider F=P(p, σ), where P is a Boolean expression to be defined below. We make sure that such expression can be represented as a single formula (not a system) with the length no greater than a linear function of r, for exmple:

$$P ( p , σ ) = \begin{matrix}⌈ {log}_{2} ( 1 / p ) ⌉ \\ {⋁}_{j = 1}\end{matrix} {σ}^{j} \qquad ( 3.0 )$$

We can manipulate the probability p more freely if we consider a conjunction of multiple RHS(3.0) expressions each one with a unique combination of negations assigned to each σ^{j} and having different upper bounds in the disjunction. In this case the total probability will be the sum of probabilities for each RHS(3.0) term.

For future use we note the following systems.

Comparison of two Boolean vectors:

$$( x > y ) ⇔ {{⋁}_{i = 1}}^{r} ( ( {x}_{i} ⋀ {y}_{i} ) ⋀ ( {{⋀}_{j = i + 1}}^{r} ( {x}_{j} ⋀ {y}_{j} ) ⋁ ( {x}_{j} ⋀ {y}_{j} ) ) ) \qquad ( 3.0 .1 )$$

Here the RHS basically says: there must be at least one bit (i) such that xᵢ is True yᵢ is False, and all higher order bits are equal.

Summation for positive integers in Boolean form:

z′ₖ=(xₖ [symbol] yₖ) [symbol] (yₖ [symbol] xₖ)—sum without carry over values (3.1.1)

vₖ=(xₖ [symbol] yₖ) [symbol] (vₖ₋₁\hat{ }(xₖ [symbol] yₖ))—carry over values (3.1.2)

zₖ=(z′ₖ [symbol] vₖ₋₁) [symbol] (vₖ₋₁ [symbol] z′ₖ)—final sum (3.1.3)

v₀=f (3.1.4)

E.g.: when xₖ=yₖ we have:

z′ₖ=f, vₖ=xₖ [symbol] (vₖ₋₁ [symbol] xₖ), zₖ=zₖ₋₁—final sum is just a shift (3.1.5)

In a similar fashion we obtain subtraction:

zₖ=(xₖ [symbol] yₖ [symbol] vₖ) [symbol] (xₖ [symbol] yₖ& vₖ)∥ (3.2.1)

(xₖ [symbol] yₖvₖ) [symbol] (xₖ [symbol] yₖ [symbol] vₖ)—final difference

vₖ=(vₖ₋₁ [symbol] xₖ₋₁) [symbol] (xₖ₋₁ [symbol] yₖ₋₁ [symbol] vₖ₋₁)∥

(xₖ₋₁ [symbol] yₖ₋₁ [symbol] vₖ₋₁)—carry over values (3.2.2)

Now, represent xy=z in Boolean form.

System for product is based on a conventional “pencil and paper” rule combined with (3.1):

Let q=f, if j<k and qₖ^{j}=yₖ [symbol] xⱼ₋ₖ₊₁, otherwise. Also let s^{k}=s⁻¹+qₖ which we'll represent in Boolean form. Combined with (3.1) the following system is obtained:

z′ⱼ=(sⱼ^{k-1} [symbol] qₖ^{j})∥(qₖ^{j} [symbol] sⱼ^{k-1}) (3.3.1)

vⱼ=(sⱼ^{k-1} [symbol] qₖ^{j})∥(vⱼ₋₁ [symbol] (sⱼ^{k-1}∥qₖ^{j})) (3.3.2)

sⱼ^{k}=(z′ⱼ [symbol] vⱼ₋₁)∥(vⱼ₋₁ [symbol] z′ⱼ)—partial sum (3.3.3)

qₖ^{j=y}ₖ [symbol] xⱼ₋ₖ₊₁, for j k—partial product (3.3.4)

qₖ^{j}=f, for j<k (3.3.5)

zⱼ=sⱼ^{r}—final result (3.3.6)

v₀=f,j<r+k (3.3.7)

Here j is the column index—indicating bits and k is the row index—indicating partial products. In (3.1),(3.2) and (3.3) k=1 . . . r.

Also for future use define operators I:I

$$( σ ) = {\sum }_{μ = 0}^{r - 1} {σ}_{μ} {2}^{μ} and B = {I}^{- 1} .$$

Comment 1 When converting a Boolean system that has a recursion to an inline expression the length of such expression can become exponential of the number of variables in case a previous recursion step variable is used in multiple instances. This is the case with (3.3) but is not with (3.0) and (3.1).

Comment 2 Evidently many other ways in addition to (3.0) of constructing expressions that are true with a given probability exist. Such as considering Boolean representation of σ=(0)mod(σ₀) for some predefined key σ₀. A multidimensional analog of this can be considered as well. In this case F will be true if and only if a random point taken within a hypercube lands on a mesh node. Such mesh will have nodes evenly spread apart, which will represent divisibility by σ₀ condition.

Comment 3 When selecting the upper and lower limits for the desired probability level, one should note that σ is not evenly but logarithmically distributed according to the Benford's law.

Comment 4 q has a lower limit imposed by dim(B(k))=k and thus by the number of variables in S.

Comment 5 In order to address Comment 4 problem, dim(B(k)) can be increased by introduction of “similar” variables e.g. if initially b=(a<3) then we add b1=(a=3); b2=(a>3); b3=(a<2) and etc (see FIG. 1.5). This method may involve manual steps and may not be required for the recursive processing conditions.

Part 3: Recursive Processing

This part defines the context for part 2 within the code. First we need to draw a distinction between independent and recursive input data D.

Definition 1. We call D recursive relative to a specific code segment S if at least some part of D is generated by a single starting value d and the generating function is S, otherwise we call it independent.

Comment 6. Recursive property of S is critical since it allows utilizing the dependency of the next step from the current one for the purposes of identifying a single monolithic execution.

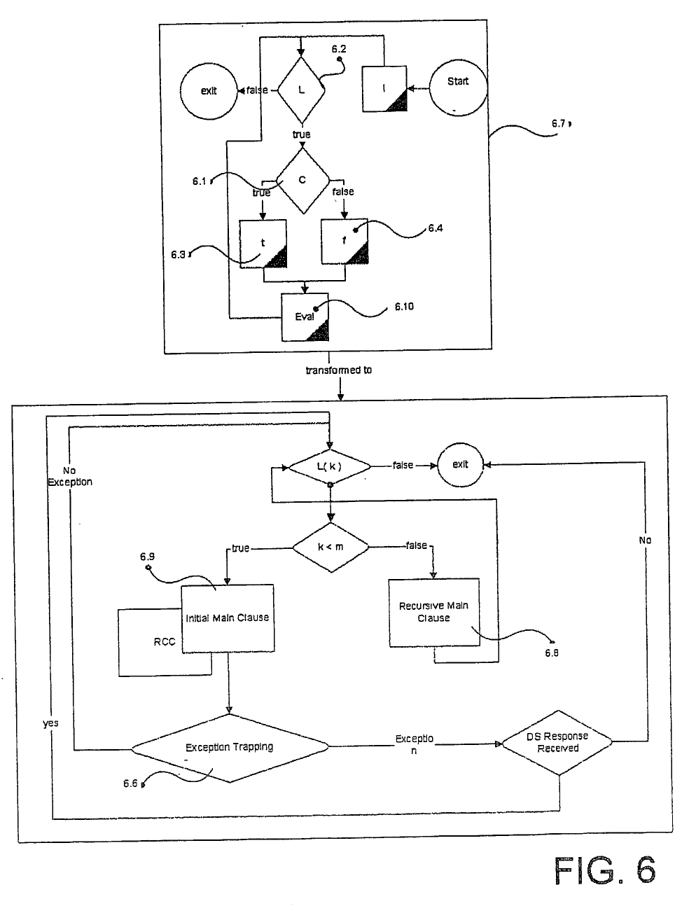

Consider a code fragment for some recursive input data (see FIG. 6.7):

p₀=I(d₁) while(L(pₖ)){(C(pₖ))?{dₖ₊₁=t(dₖ)}:

{dₖ₊₁=f(dₖ); pₖ₊₁=Evaluate (dₖ₊₁)} (4)

where pₖ is a Boolean vector of dimension D, L(pₖ) is a loop condition (see FIG. 6.2), k is the loop index, C(pₖ) is an inner loop condition (see FIG. 6.1), t( ) and f( ) are some non-recursive functions or more generally, two instruction sets (see FIGS. 6.3 and 6.4). They are non-recursive because according to Part 1 recursive function handling and conditional aggregation includes recursive loop conditions into L and C. Evaluate( ) is a function that returns Boolean vector based on the processed loop data (FIG. 6.10).

If |D|<s (see definition of s below), we require that t(.) and f(.) were chosen so that they mainly contain the logic related to calculating dₖ₊₁ based on dₖ and other data associated with dₖ₊₁. More precisely we require that t(.) and f(.) may be executed out of sequence irrespectively of the value of C(pₖ). For example such requirement rules out the use of some communication protocol functions as t(.) and f(.). It is important to note that the correct sequence will be established no more then a fixed O(1) number of steps away from the redundant call of t(.) or f(.). Therefore a sequence correction may be issued for such outside communication. As described by Part 1 c), d) this gets transformed into:

p₀=I(d₁) while (true){(L(pₖ))?(exit loop):(continue); (L(pₖ) [symbol] C(pₖ))?

{dₖ₊₁=t(dₖ)}:{dₖ₊₁=f(dₖ)}; pₖ₊₁=Evaluate (dₖ₊₁)} (5)

Denote 'C(pₖ)=L(pₖ) [symbol] C(pₖ) (see FIG. 6.5). Also assume certain security level s such that performing some operations 2^{s} times is not feasible (e.g. s=75) and introduce a number g=[s/D].

The intruder's objective is to remove F and always correctly run 'C. In order to resist this, our objective now is to satisfy the following requirements (*):

a) Conceal real Co.

b) Produce a controlled malfunction in every q % of cases in the very beginning of the process.

c) Recover from this malfunction immediately by use of DSR (see below)—this means using some exception trapping technique (FIG. 6.6).

d) Ensure that this technique does not help in identifying the proper processing logic for 'C( ).

e) Rule out the possibility of directly substituting some variables with their calculated values.

f) Eliminate the possibility of guessing the correct value of 'C( ) by adding multilevel malfunctioning with the depth d.

g) Resist the brute force attack where the truth table of 'C(.) can be fully constructed.

To this end we shall show that the following code segment is equivalent to (4) in (100-q) % of cases and satisfies the above constraints.

We shall say that a Boolean expression Q(pₖ}) significantly depends on {pₖ} if there is no such subset of variables in {pₖ} that Q({pₖ}) is independent of.

In order to satisfy constraint b) we need the main expression to function without invoking RCC a fixed number of steps after the loop start. The loop start is identified by not having any of the prior steps and therefore the first step is non-recursive.

This is the main critical property of start that we'll use. One of the central objectives is to ensure that RCC-free execution may not be adopted to run at start as well. To this end we segregate out a special condition that can only execute if d of the previous evaluations were performed. It is also critical that such condition significantly depends on these previous steps in order to rule out the possibility of forging these steps with any RCC-free data. In other words we need to transform a single step recursion into a multi-step one.

We also need to satisfy f) and therefore we consider d evaluations in the beginning as our “start”.

At the same time g) dictates that all steps must depended on at least s variables, including the first step. Such dependency must also be significant. Otherwise if a subset of significant variables is isolated, then even without constructing a truth table for the new artificial variables, the truth table for the whole expression can be created. This is insured by an application of Loop Variable Increment Procedure prior to the next step (5).

Let also T is some test expression, unrelated to C, which we'll use for exception trapping. Exception trapping gets activated if RCC has fired.

We shall now replace (4) with the following set of code segments (6):

| | |
|---|---|
| p₀ = I(d₀) | // compute first Boolean vector p based on the initial input |
| | data D |
| | // initial evaluation I( ) is considered generally different from |
| | the recursive evaluation |

BL(F(p₀), C(p₀))?(d₁ = t(d₀)) : (d₁ = f(d₀))

| | |
|---|---|
| (BL(F(p₀), T (p₀)) ≠ T (p₀) ) ? (DS Request) : (continue) | (6.1) |
| p₁ = Evaluate(d₁) | |
| k:=1 | |

The code fragment above we call the Initial Main Clause, shown as FIG. 6.9.

While (j<d){c^{j}₁=αⱼ(p₁, p₀) [symbol] RCC(p₀)}

The line above is the Exception Trapping Clause, shown as FIG. 6.6.

While (True) {

V(pₖ, pₖ₋₁) = ĵ (cₖ^{j}\hat{ }αⱼ (pₖ, pₖ₋₁)) [symbol] )┐cₖ^{j} \hat{ }┐αⱼ(. . .))

// The above expression for V( ) is not to be actually included in the code -
it is to be retained // in the blended expression s below

| | |
|---|---|
| If BL(V(. . .)\hat{ }C(pₖ))dₖ₊₁ = t(dₖ) | (FIG. 1.12) (6.2) |
| Else dₖ₊₁ = f(dₖ) | |
| pₖ₊₁ = Evaluated(dₖ₊₁) | |
| While (j<d) {cₖ₊₁^{j} = αⱼ(pₖ₊₁, pₖ) \hat{ }V(pₖ, pₖ₋₁)} | (FIG. 1.11) |
| k:=k+1 | |

}

This code fragment we call the Recursive Main Clause, shown as FIG. 6.8.

The key to disrupting this one would be locating an appropriate pₖ₋₁ so that the unknown V(pₖ, pₖ₋₁) is true and the certificate values can be calculated. So for a given starting (disrupting) pₖ one would need to get any pₖ₋₁ such that c^{j}_{k=α}ⱼ(pₖ, pₖ₋₁) for any applicable c^{j}ₖ. One could select pₖ₋₁ at random and then wish to compute c^{j}ₖ. The problem would then be with the fact that αⱼ is also not known and again comes in bundled with the previous V( ). This process now becomes recursive and the only other remaining end would be the initial RCC—which is what we want.

Satisfaction of other constraints also follows from the above construction.

Here we have omitted the loop itself with the other loop related condition for brevity.

Remarkably, code segment (6) allows to establish significant dependency of all iteration steps on the first step, without involving any properties of the recursive functions t( ) and f( ).

Complexity of the inverse transformation is now insured by the secure level s and efficiency of the blending procedure BL. FIG. 1.17 shows the place of Blending Procedure in the flow.

Part 4: Independent Processing (FIG. 1.13)

Independent processing itself lacks the critical property noted in Comment 6 and therefore one cannot clearly distinguish between the code that executes twice and processes 2n data records and two executions that process n records each from different record sets.

An attack that exploits the lack of steps interdependence would consist of adding a set of m=d Boolean vectors H for which the code (6) has already been correctly executed and the certificates {cₖ₋ⱼ} were already generated. Such strategy we'll call H-strategy. H-strategy would allow the attacker to eliminate a chance of an RCC filing within the first m steps—which is the only time it is allowed to fire.

In order to compensate for this, we artificially convert the independent code segment to a special recursive form in an exponentially difficult to invert way and introduce a certain processing sequence that would make adding such elements H impossible.

We are now given:

while (true) {(L(pₖ))?(exit loop):(continue); ('C(pₖ))?

{t(dₖ); }:{f(dₖ); }}, 'C(pₖ)=L(pₖ) [symbol] C(pₖ) (5.b)

Here let p_{μ}={p_{μτ}}, τ=1 . . . L, μ=1 . . . n and n>>m, n depends on user data batch size and m is only defined by the program structure and k is the loop index.

Since the processing is independent we can process {p_{μ}} in any sequence. Let ζ(p_{μ})={ζ_{τ}(p_{μ})}τ=1 . . . L is some Boolean system which solution represents a 3-SAT problem such that the map ζ(.) is bijective and: {p_{μ}}→{'e_{μ}}, 'e_{μ}=ζ(p_{μ}). It is also easy to verify that a given 'e_{μ} was obtained via the application of ζ(.):

'e_{μ} [symbol] ζ(p_{μ})≡t (9)

Using this we order {'e_{μ}} by I('e_{μ}) values and remove all duplicate elements in order to eliminate multiple replay of the same step in the intruder's attack. The fact that ζ(.) is bijective will ensure that removal of duplicate {'e_{μ}} will mean the removal of duplicate {p_{μ}} and only those.

An example of bijective ζ(.) is presented in Section B.1.

We shall now do the processing in a new way—we will be processing two steps as a one, under a common Boolean condition. Instead of considering four regular conditions:

'C(pₖ)?(t(dₖ)), ┐'C(pₖ)?(f(dₖ)), 'C(pₖ₊₁)?(t(dₖ₊₁)), ┐'C(pₖ₊₁)?(f(dₖ₊₁)),

we shall consider four new ones:

'C(pₖ₊₁) [symbol] 'C(pₖ)?(t(dₖ₊₁); t(dₖ)), ┐'C(pₖ₊₁) [symbol] 'C(pₖ)?(f(dₖ₊₁); t(dₖ)),

'C(pₖ₊₁) [symbol] ┐'C(pₖ)?(t(dₖ₊₁); f(dₖ)), ┐'C(pₖ₊₁) [symbol] ┐'C(pₖ)?(f(dₖ₊₁); f(dₖ)).

The loop execution will be described in form of these pairs: we start with μ=([n/2], [n/2]+1) for step 1, this element we'll denote γ. Step 2 will process p with index

B(2)=([n/2]−1, [n/2]+2),

step 3: B(3)=([n/2]-2, [n/2]+3) and etc. until all elements are processed. Such sequence we'll call Bootstrap Sequence or B-sequence and we'll say it consists of {γₖ}, where γ=γ₀ and γₖ=e.

We shall enforce B-sequence by requiring that B₁ (k+1)<B₁ (k) and B₂ (k+1)>B₂ (k) within the main condition itself. A Boolean function that checks each of these inequalities we denote Ψ which will be based on expression (3.0.1).

Such processing sequence ensures that in order to process H elements in the beginning, they would have to be inserted in the vicinity of γ between the first two real elements that need to be processed, in such way that H∩{p_{μ}}=Ø. Otherwise if RCC would fire while processing γ . . . γₘ it would also fire while processing h₀. . . hₘ. Such insertion would result in “sacrificing” some of {p_{μ}} elements since B-sequence is expanding and once any p_{μ} is skipped it can no longer be processed. Even though such step may be possible in certain cases, this is not the main obstacle. In order to establish hεH such that

ζ(h)ε(I(p₁), I(pᵤ)) one would have to attempt solving all systems ζ(h)=α for all αε (I(p₁), I(pᵤ) such problem is not just NP-complete. There is no guarantee that such solution can be found at all. Moreover, such solution will need to be found m times in order to determine all elements of H which is almost certainly impossible.

In case with ζ(.) from Section B.1 the solution can be found via the inverse matrix. This however provides almost no benefit to the intruder since H will have to be found for every set {p_{μ}} processed, which will trigger RCC on every attempt just as it would in any other case.

Also in order to increase the number of variables to a secure level s we will use the same method as in (6). This can certainly increase the number of Boolean expression evaluations 2^{[g/2]} times, however Boolean expression evaluation is believed to be a relatively fast operation and should normally take negligible time in comparison to the execution of t(.) and It is also important to note that unlike (6) there will be no redundant executions of t(.) and f(.) due to the fact that all {pₖ} are already known, and therefore all constraints on them can be lifted.

The new version of condition (6) will then also include verification for B-sequence as well as the check (9):

While (Not all elements {dₖ} are processed) {

pₖ = Evaluated(dₖ)
′eₖ^{j} = ξⱼ(pₖ)

}
While (k<m) {

| (F(pₖ)\hat{ }′C(pₖ)))? (t(dₖ); cₖ = α^{t}(pₖ); ):(f(dₖ); cₖ '2 α^{f}(pₖ); ); | |
|---|---|
| (BL(F(pₖ), T(pₖ)) ≠ T(pₖ)) ? (DS Request) : (continue) | (8.a) |

}

Here we again combine F-RCC—with some T so that F remains secret in order to avoid letting the intruder know what values trigger RCC.

While (k≧m) {

$$BL ( {}^{′} C ( {p}_{k} ) ⋀ ( {{⋀}_{j = k - m}}^{k} Ψ ( ς ( {p}_{j} ) , ς ( {p}_{k} ) ) ) ⋀ ( {{⋀}_{j = 1}}^{D} ( {}_{}^{′}{e}{}_{k}^{j} ⋁ {ς}_{j} ( {p}_{k} ) ) ) ⋀ ( {}^{′} C ( {p}_{k - 1} ) ⋀ ( {c}_{k} ⋁ {α}^{t} ( {p}_{k} , {p}_{k - 1} ) ) ) ⋁ ( {}^{′} C ( {p}_{k - 1} ) ⋀ ( {c}_{k} ⋁ {α}^{f} ( {p}_{k} , {p}_{k - 1} ) ) ) ) ) ? ( t ( {d}_{k} ) ; {c}_{k + 1} = {α}^{t} ( {p}_{k + 1} , {p}_{k} ) ; ) : ( f ( {d}_{k} ) ; {c}_{k + 1} = {α}^{f} ( {p}_{k + 1} , {p}_{k} ) ; ) \qquad \text{(7.a)}$$

The use of certificates here is critical in order to ensure that any “sacrifice” of some set in the vicinity of γ will lead to a failure in processing of all other elements: if the first m-steps are abandoned because they contain RCC and the next m are abandoned because they refer to the first m steps via

$${{⋀}_{j = k - m}}^{k} Ψ ( {}_{}^{′}{e}{}_{j}^{} , {}_{}^{′}{e}{}_{k}^{} ) ,$$

then processing of all other steps might be possible if no certificates were used because all other steps will refer to the second set which is properly sequenced; however with the certificates this will not be possible because the certificate values will be needed for the second set as well as recursively for all other steps.

Comment 8 In order to ensure that the new processing sequence does not hinder the performance, two strategies are available:

Parallel preprocessing when a portion of input data is preprocessed first, in which case the main processing starts in parallel with the thread or process that prepares the next data portion.

Embedding preprocessed data into the input data outside the given application scope. This would be appropriate to do with media player applications where a distribution file will have such preprocessed data added before the distribution to the client so that the client application—the player—can skip this conversion step.

Part 5: Secure Data Preprocessing

The second part of Comment 8 is specifically applicable in cases where although the data processing is independent, the sequence is still important for other reasons. In this case {p_{μ}} can be encrypted recursively away from the client and processed on the client side without any change of sequence:

Introduce a Boolean encryption function E:

E(p_{μ}, p_{μ-1})={E_{ν}(p_{μ}, p_{μ-1})}={e_{ν}^{μ}}=e, ν=1 . . . m.

This is in essence a logical system, which provides a bijective map with the inverse:

E⁻¹(E(p_{μ}, p_{μ-1}), p_{μ-1})={E_{ν}⁻¹(E(p_{μ}, p_{μ-1}), p_{μ-1})}=p_{μν}}=e,ν=1 . . . m.

As it's seen from this definition when we do the encryption we use the previous vector in order to encrypt the current one. When we decrypt we also have to use the previous unencrypted vector in order to decrypt the current one. By doing so we introduce recursion.

For a given 'C(p) we consider 'C(E⁻¹ (e^{μ}, p_{μ-1})) 'C(p) and the code looks like:

('C(E⁻¹(e^{μ}, p_{μ-1})))?(t( . . . )):(f( . . . ));

Note that unlike in (4), p_{μ} is calculated unconditionally (it is known initially), with no regard to the value of 'C( ). However this is not preventing us from using the protection scheme (6)-(8) since the certificates will still depend on the value of 'C(.).

Following is one of the ways that might be used to construct a Boolean system E with its inverse.

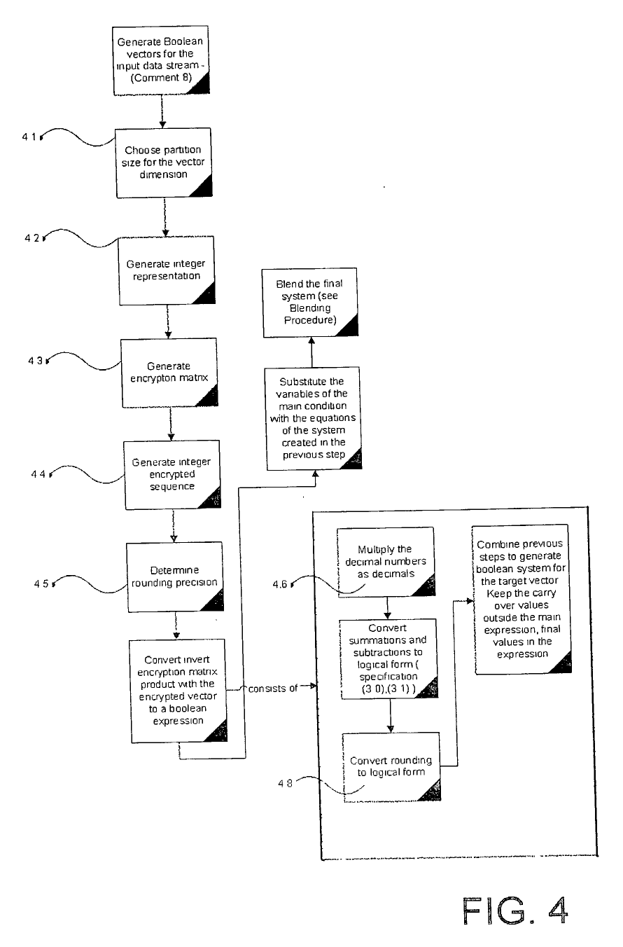

For m=dim(p) consider m₀<m:'m=m/m₀ is integer (FIG. 4.1) and 'p={'pₖ},

k=1 . . . 'm, where

'pₖ={p_{μ+k}} and here μ=1 . . . 'm₀. Now consider an integer vector h (FIG. 4.2):

$$\{ {h}_{k} \} = \{ I ( {}_{}^{′}{p}{}_{k}^{} ) \} = \{ {\sum }_{μ = 1}^{{}_{}^{′}{m}{}_{0}^{}} {p}_{μ + k} {2}^{μ - 1} \} ,$$

k=1 . . . 'm. Choose integer matrix AεGL('m), i.e. dim(A)='m×'m, det(A) 0(FIG. 4.3).

This matrix represents a key secret to the end user. Based on this we define

E(p_{μ})=B(Ah_{μ}+h_{μ-1})=g_{μ}(FIG. 4.4). To obtain E⁻¹ (g_{μ}) we consider

A⁻¹ (I(g_{μ})-h_{μ-1}) where when multiplying matrix by vector we replace all decimal numbers with Boolean vectors, all summations and subtractions here are replaced with the corresponding expressions over Booleans, multiplications are left in decimal form (FIG. 4.6), see (3.0) and (3.1).

In this way we can keep the expressions for carry over values v outside the main expression and avoid expanding recursion (see comment 1).

As a result we form a single logical expressions that depends on g and the coefficients of A⁻={v_{μj}}.

Comment 7 Since we cannot expect that A⁻¹ is also an integer matrix we'll have to estimate a precision of its elements and consequently the length of the corresponding Boolean vectors such that we can accurately restore p:

We'll estimate the smallest meaningful fraction 6 that may be added to the coefficients of A⁻¹ so that the result of multiplying the row of this matrix by h will produce a different integer. This smallest fraction will be the sought precision.

It follows from the definition that max({hₖ})=2^{'m}₀⁻¹, and we assume that all 'm numbers in a row are positive. As it's easy to see under such conditions any coefficient precision error will be magnified to the greatest possible extent and

$${\sum }_{j = 1}^{{}^{′} m} ( {v}_{μ j} + δ ) {2}^{′ {m}_{0} - 1} - {\sum }_{j = 1}^{{}^{′} m} {v}_{μ j} {2}^{′ {m}_{0} - 1}$$

1 when δ1/('m2^{'m}₀⁻¹) (FIG. 4.5).

This rounding step needs to be expressed in Boolean form (FIG. 4.8). Since (3.0) and (3.1) do not account for the decimal point, both input vectors can be multiplied by 2^{p+1}, where 2^{p} is the desired rounding precision. This will convert the numbers to the regular Boolean vector case. The final result {zₖ} will then simply have to be shifted back by re-indexing variables: k:=k−p. Since the vector before the encryption was integer we can be sure that zₖ=t, for k<0. This completes the conversion to Part 4.

Comment 9: Data Specific Response (DSR)

Let d=(d), τ=1 . . . m, is the matrix of input vectors for C for the first m steps sent to the Licensing Server S. S checks the license database and if the license is valid, takes each d_{τ} and computes C(d_{τ}) and certificates {cₖ^{τ}} which are then returned to the client (FIG. 5.9). Once (C(d_{τ})) and {cₖ^{τ}} are received by the client it enables the execution of the first m steps. For step m+1 the certificates will be used correctly since the m'th step condition was evaluated properly using DS Response.

Part 6: Loop Variable Increment Procedure

This procedure is based on executing multiple steps as part of one iteration under some common logical conditions in order to increase the number of significant variables to the secure level S.

For the number of variables initially available on one iteration step—D>1 (e.g. 10), we can consider sequences of g Boolean vectors (e.g. g=7, s=75). Construct the following sequence of the length 2^{g}:

{p¹₂, p²₂}, {p₃¹¹, p₃¹², p₃²¹, p₃²²}, . . . , {p^{π(g)}_{g}}, where π(g)=(π₁(g), . . . , π_{g}(g)), and each π_{υ}(g)ε{1,2}.

Here we let p¹₂=t(p₁), p²₂=f(p₁), p¹¹₃=t(p₂), p¹²₃=f(p¹₂), p²¹₃=t(p²₂), . . . .

This sequence represents a binary tree. We shall extract all distinct branches from this tree and consider them separately. There are 2^{g} of such branches each one matching the following Boolean condition:

$${{⋀}_{ρ = 1}}^{g} δ ( ρ ) Q ( {p}_{ρ} ) ,$$

where δ(92 )ε{┐, ┐┐}, here ┐┐ means no negation.

Comment 10 Using a binary search technique in order to locate all negations can also speed up evaluations of expressions of type

$${{⋀}_{ρ = 1}}^{g} δ ( ρ ) Q ( {p}_{ρ} ) ,$$

for example:

Let initially L=1 and u=g,

Start( )

$$\{ If ( {{⋀}_{ρ = L}}^{u} Q ( {p}_{ρ} ) )$$

return (u, L);/end this call of Start( )/

Else If

$$( ⌉ ( {⋀}_{ρ = L}^{[ u / 2 ]} Q ( {p}_{ρ} ) ) ⋀ {⋀}_{ρ = [ u / 2 ] + L}^{u} Q ( {p}_{ρ} ) )$$

{([u/2]-L=1)?return (L, L+1); u:=[u/2]; ret=Start( ); store(ret);}

Else If

$$( {⋀}_{ρ = 1}^{[ u / 2 ]} Q ( {p}_{ρ} ) ⋀ ⌉ ( {⋀}_{ρ = [ u / 2 ] + L}^{u} Q ( {p}_{ρ} ) ) )$$

{(u-[u/2]-L=1)?return (u, u−1); L=[u/2]+L; ret:=Start( ); store(ret);}

Else If

$$( ⌉ ( {⋀}_{ρ = L}^{[ u / 2 ]} Q ( {p}_{ρ} ) ) ⋀ ⌉ ( {⋀}_{ρ = [ u / 2 ] + L}^{u} Q ( {p}_{ρ} ) ) )$$

{([u/2]-L=1)?store(L, L+1):{u:=[u/2]; ret:=Start( ); store(ret);};

{([u/2]+L−u=1)?store(u, u−1):{L=[u/2]+1; ret:=Start( ); store(ret)}}

/Use all returned values to identify the sought expression/

Such algorithm is evidently very easy to implement on multiple CPUs.

Part 8: Logical Expression Blending Procedure

Assume we are given Boolean expressions A and B both in the same fairly general form:

$${⋀}_{j} ( {⋁}_{k ( j )} {δ}_{{k}_{1}} {y}_{{k}_{1}} ⋀ {δ}_{{k}_{2}} {y}_{{k}_{2}} ⋀ … ⋀ {δ}_{{k}_{d}} {y}_{{k}_{d}} ) ≡ {⋀}_{j} ( {⋁}_{k ( j )} {c}_{k ( j )} ) ,$$

where as always δₖε{┐, ┐┐}. We shall make a substitution for each conjunctive term cₖ by selecting a single variable, with it's negation if the negation is present. Let cA is one of such terms for A and cB is for B, d[A](k, j) is number of factors in cA and d[B](k, j) in cB—for brevity we'll call them just d or d[A] or d[B] with the it's arguments following from context. The steps to “Blend” A and B in a way that in average only exhaustive guessing is possible in order to come up with A and B again, are as follows:

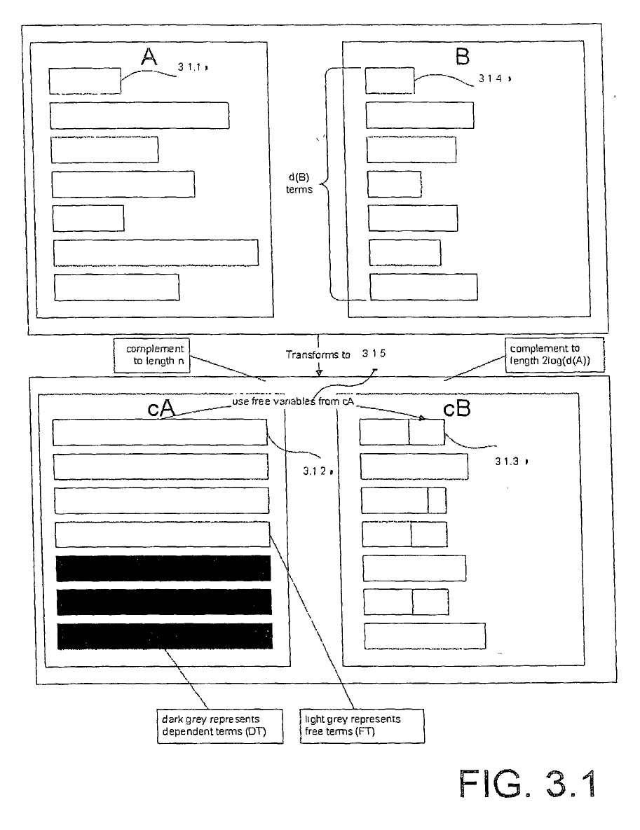

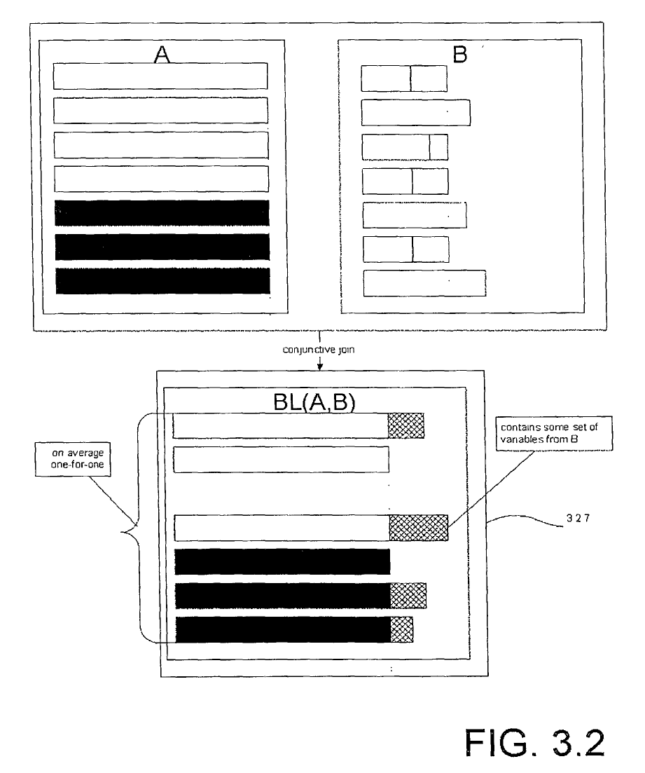

1.Replace all C[A]ₖ₍ⱼ₎ (FIG. 3.1.1) with δₖ_{₁}xₖ_{₁} [symbol] δₖ_{₂}xₖ_{₂} [symbol] . . . [symbol] δₖ_{ₙ}xₖ_{ₙ} (FIG. 3.1.2) dependent on 2n variables—altogether for all k(j) with fixed j—such that for k≦[d/2] each term is called a free term and all free terms in total depend on n variables I_{f}, which we'll call free variables. This we do by computing C[A]ₖ₍ⱼ₎ and replacing it:

C[A]ₖ₍ⱼ₎=δₖ_{₁}xₖ_{₁} [symbol] δₖ_{₂}xₖ_{₂}. . . [symbol] δₖ_{ₙ}xₖ_{ₙ} (i)

such that False C[A]ₖ₍ⱼ₎ are mapped onto free variables aid True C[A]ₖ₍ⱼ₎ onto dependent variables. For k>[d/2] we will have a combination of dependent DT and free terms FT. For DT the sign of every variable must be the same in all terms since all instances of this variable must be true at the same time. This lets us denote DT(k)=True if variable with index k is without negation and DT(k)=False if it's with negation. For the generality sake we assume them all dependent and these terms we'll make dependent on all variables I.

2. For each input Boolean vector y={yₖ} k=1 . . . n let |F(y)| is the number of False values and |T(y)| the number of True values. If |F(y)|<|T(y)| then we use cD*:cD* (┐yₖ)=cD (yₖ) and we assign zₖ=┐yₖ, otherwise we use cD (yₖ). For example if cD=. . . [symbol] (┐a [symbol] ┐b) [symbol] . . . =. . . [symbol] ┐┐(a [symbol] ┐b) \hat{ }. . . =. . . [symbol] ┐(┐a [symbol] b) [symbol] . . . =. . . [symbol] ┐ (c [symbol] ┐d) [symbol] . . . =. . . [symbol] (┐c [symbol] d) [symbol] . . . , where c=┐a and b=┐d. And almost identically: . . . [symbol] (a [symbol] ┐b) [symbol] . . . =. . . [symbol] ┐┐(a [symbol] ┐b) [symbol] . . . =. . . [symbol] ┐(┐a [symbol] b) [symbol] . . . =. . . [symbol] ┐(c [symbol] ┐d) [symbol] . . . =. . . [symbol] (┐c [symbol] d) [symbol] . . . .

3. Generate d terms for cB (FIG. 3.1.4) by randomly replacing one δₖyₖ in each term with δₖ_{₁}xₖ_{₁} [symbol] δₖ_{₂}xₖ_{₂}. . . [symbol] δₖ_{_{2Log(d)}}xₖ_{_{2Log(d)}} (FIG. 3.1.3) altogether dependent on all I_{f} (FIG. 3.1.5) variables and any needed number of I\I_{f} variables. We essentially repeat step 4, making part of I_{f} dependent (I_{fd}), |I_{fd}|=[n/2] and the other part (I_{f}\I_{fd}) such that each LHS from F(y) will get a matching RHS equal to False. Such RHS will be

δₖ_{₁}xₖ_{₁} [symbol] δₖ_{₂}xₖ_{₂} . . . [symbol] δₖ_{_{2Log(d)}}xₖ_{_{2Log(d)}}

where one of the factors will be from (I_{f}\I_{fd}) and equal to False. The rest of the variables can be then taken from anywhere in I including I\I_{f}.

4. If we see some xₖ with and without the negation, we treat them as two separate variables from the substitution point of view. Obviously since this remains constant relative to pₖ we have to take these steps only once and then for each iteration only worry about the values of yₖ as far as assigning values to the new substitution variables.

5. Combine and eliminate terms in cD=cA [symbol] cB. When selecting the signs for each variable xₖ in the substitutions (i) we shall perform a random sign pick so that probability of any given sign being negation next to any variable in (i) in cA or cB is 0.5. Our objective is to have in average less then 1 term for each term in cB conjunctively combined with every term in cA (FIG. 3.2.7). To this end assume we have d terms in cA and each term is n long, if we now take 2Log₂ (d) factors in each term in cB, then in the average we'll find that Log(d) factors in such term already exist in C term—since it contains half of the total number of variables. Now the probability of two random binary vectors of length s being equal is 2^{-s} and so the probability of cA term “survival” after it met cB tern is 1/d and finally in average only 1 final term will be in average produced for each cB term.

6. We shall finally assign {xₖ} for kεI\I_{f} (dependent) to DT[A](k), for kεI_{fd} to DT[B](k) and for kεI_{f}\I_{fd} to False (we use them where RHS is yₖεF(y)). The rest of the variables we assign to random constants with respect to {yₖ } values.

The result of these steps we'll denote BL(A,B).

Comment 11 The Blending Procedure above implies an explicit calculation of C[A]ₖ₍ⱼ₎ in order to perform substitution (Step 1). This discloses C[A]ₖ₍ⱼ₎ shedding some light on A, this is tolerable in case A=RCC. In case of (6.2) for example, αⱼ must be chosen to conjunctively include separate disjunctive factors and disjunctively include separate conjunctive factors (in order to take care of ┐αⱼ).

Comment 12 The described scheme (Part 1-Part 8) represents a private key only encryption method (not just a one-way function) where the secret key is the expression we are protecting itself. Therefore in general any deciphering algorithm will have to be exhaustive. The protected algorithm will consume all the processing power from the client (some will be still left though) and rarely will need to verify the license, yet it will still not have the most critical part of the program's logic. Arguing this by saying that 'C( ) contains C( ) is just as good as saying that a white sheet of paper contains any word printed in White Ink.

Comment 13 The protection of the conditions nested in the loops (Part 3 and 4) is suggested as the best mode of operation. This is mainly due to that a sufficient number of variables can be achieved within the Boolean expressions in an automated fashion.

Also in case with independent processing when secure data preprocessing is possible, the approach described in Part 5 is suggested as more performance effective.

What is claimed is:

1. A process of converting a computer program to a form resistant to unauthorized use, whereby said resistant form becomes comprised of a client program, communication channel allowed to have a low bandwidth and be infrequently used and a secure program capable of execution in a time substantially less then the client program comprising the steps of:
(a) providing a level of complexity of said computer program's logical conditions such that without knowledge of said logical conditions, determining the logical conditions by a random guess would take prohibitively long time, by means of:
(1) combining the logical conditions of said computer program, including those used to control loop execution, so that they achieve substantial length;
(2) converting recursive functions to iterative loops; and
(3) increasing a number of Boolean variables of said logical conditions in said loops to a sufficiently secure level by means of a loop variable increment procedure
(b) providing that said client program contacts said secure program via said communication channel with any desired probability and any of said computer program's input data size by means of:
(1) conjunctively adding a random condition controller logical expression to the logical conditions outside of the said computer program loops;
(2) converting loops of said computer program to a form where execution of a considerably small set of controlling steps becomes logically necessary to correctly execute other steps whereby said random condition controller conjunctively added to the logical expressions governing said controlling steps, gets invoked a number of times independent of a number of loop iterations said computer program performs; and
(3) performing a blending procedure on a plurality of said logical conditions containing said random condition controller to provide a resulting expression whereby separating the random condition controller from said resulting expression would require prohibitively long time;
(c) providing means for said program to use input data specific small data packet received from said secure program over said communication channel in order to resume correct execution
whereby said client program can execute all instructions of the computer program with an exception of a number of special instructions that is small and independent of an initial input data size
whereby said client program will send a small and independent of the initial input data size request and require a small data specific response via said communication channel from said secure program when executing said special instructions
whereby said secure program will require an amount of time that is small and independent of initial input data size to generate said data specific response for said client program in case said client program submits said input data with a valid license
whereby without knowing said secure program restoring the computer program or otherwise achieving correct execution requires more then a polynomial time.
